(19) United States
(12) Patent Application Publication
(10) Pub. No.: US 2006/0229013 A1
(43) Pub. Date: Oct. 12, 2006

(54) Wireless communication module

(75) Inventors: Chen-Yen Shih, Taoyuan Hsien (TW); Chin-Shan Lin, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/338,682

(22) Filed: Jan. 25, 2006

(30) Foreign Application Priority Data
Apr. 8, 2005 (TW) 94111131

(51) Int. Cl. H04B 7/00

(52) U.S. Cl. 455/41.2

(57) ABSTRACT

A wireless communication module. A base includes a first surface and a at least one cavity formed on the first surface. First electronic element is disposed within the cavity. A plate includes a second surface. A wireless transmitting element is formed on a second surface in a patterning method and exposed to the outside of the wireless communication module. The plate is coupled to the base.

### BACKGROUND

The disclosure relates to a wireless communication module, and more particularly to a wireless communication module integrating an antenna into a bluetooth module.

Wireless communication technology has grown in recent years. Bluetooth technology has experienced focused development. A bluetooth module can rapidly transmit images, sound, and data. Bluetooth modules are lightweight have low power consumption, and offer a variety of ways to transmits data. The combination of the bluetooth modules with a mobile communication device, research into reduction of the weight and the size of the bluetooth module.

FIG. 1A is a schematic diagram of a conventional wireless communication system. The conventional wireless communication system 10 comprises a signal processing module 30 and an antenna 12. Signal processing module 30 is a bluetooth module comprising a bandpass filter 14, a balance-unbalance converter (Balun) 16, a bluetooth chip 32, a digital signal input/output (I/O) port 18, and an analog signal I/O port 20. FIG. 1B is a structural diagram of the conventional wireless communication system shown in FIG. 1A. The conventional wireless communication system 10 utilizes a surface mounting technology (SMT) to mount signal processing module 30, antenna 12, and other passive components (not shown) on a printed circuit board 40 disposed in a wireless communication device, such as a mobile phone or a notebook, for transmitting data. The structure of the conventional wireless communication system cannot meet size or weight requirements.

To satisfy the above requirements, a conventional method disclosed by Taiwan patent No. 5,12,654 utilizes a low temperature co-fire ceramic (LTCC) process to form multi-layer ceramic (MLC) cover for passive components comprising high frequency circuits. Electronic elements, such as the filter, the Balun, the antenna, and the capacitor can be disposed in the MLC to form a bluetooth module integrating mobile communication and wireless transmission. The bluetooth module can utilize metal, such as gold, silver, or copper, and cooperates with a low power loss ceramic base to increase performance of a radio frequency signal, integrate with a wireless communication system, simplify manufacturing steps, and increase reliability.

The conventional method must dispose many components in the bluetooth module, however wherein the majority of the components are first formed respectively, and then disposed into the MLC. For example, since the bluetooth module comprises many electronic elements, the volume of the bluetooth module is determined by the total volume of the electronic elements. Since the volume of the antenna is increased, the volume of the bluetooth module is difficult to reduce.

### SUMMARY

An exemplary embodiment of a wireless communication module comprises a signal processing module and a wireless transmitting module. The signal processing module comprises a base, and a plurality of first and second electronic elements. The base comprises a first surface and a plurality of cavities formed on the first surface. The wireless transmitting module comprises a plate and a wireless transmitting element such as an antenna.

The signal processing module is a bluetooth module. The first electronic elements comprise a bluetooth chip, a resistor with high-resistance, and a capacitor with high capacitance. The second electronic elements comprise passive components selected form a group of a filter, a balance-unbalance converter, an inductor, a capacitor, or a resistor.

The base comprises a multi-layer ceramic structure formed by a low temperature co-fire ceramic (LTCC) technology. The cavities are formed on the first surface. The first electronic elements are embedded in the cavities using a surface mounting technology (SMT). The second electronic elements -are formed in the multi-layer ceramic structure by a patterning method.

The plate comprises a second surface. The antenna is formed on the second surface by patterning method. The plate is made of a material with a low permittivity selected form a group of a glass fiber, an organic compound, or a polytetra-fluoroethylene (PTFE). The antenna is formed by ink printing or etching. The antenna comprises a metal material.

A plurality of connection pads such as a surface mounting bonding pad or a die bond bonding pad are disposed on the first surface for connecting the plate and the bonding pad of the base.

The wireless communication module disposes the antenna outside the bluetooth module formed by MLC. Thus, the volume, manufacturing difficulty, and time, as well as cost can be reduced.

### BRIEF DESCRIPTION OF THE DRAWINGS

The invention can be more fully understood by reading the subsequent detailed description and examples with reference made to the accompanying drawings, wherein:

FIG. 1A is a schematic diagram of a conventional wireless communication system;

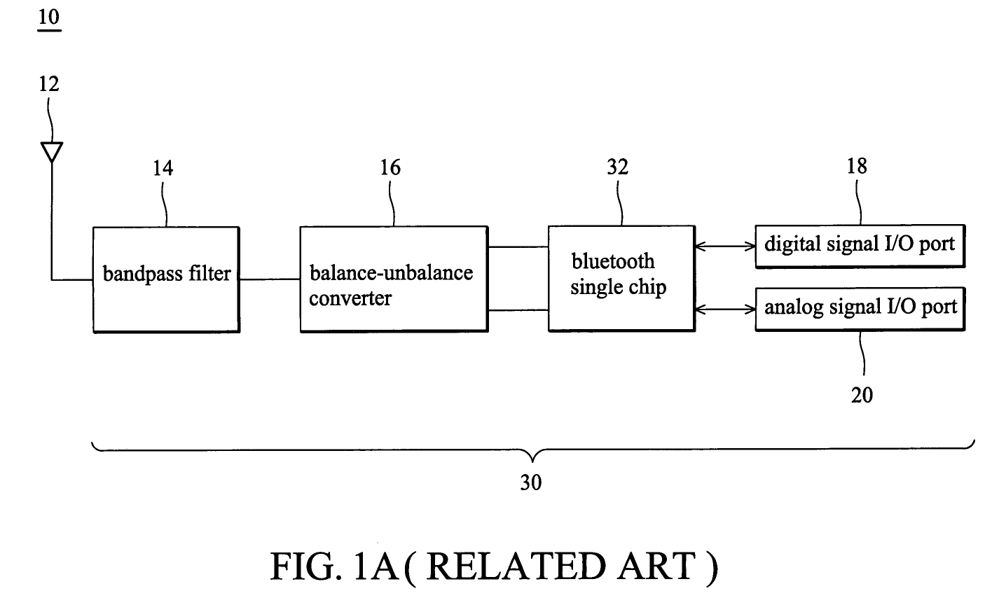

FIG. 1B is a structural diagram of the conventional wireless communication system shown in FIG. 1A;

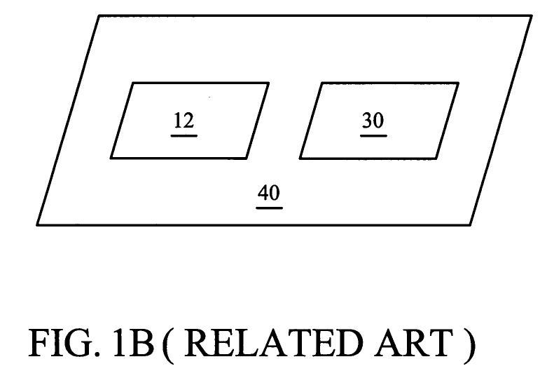

FIG. 2 is a structural diagram of an embodiment of a wireless communication module.

### DETAILED DESCRIPTION

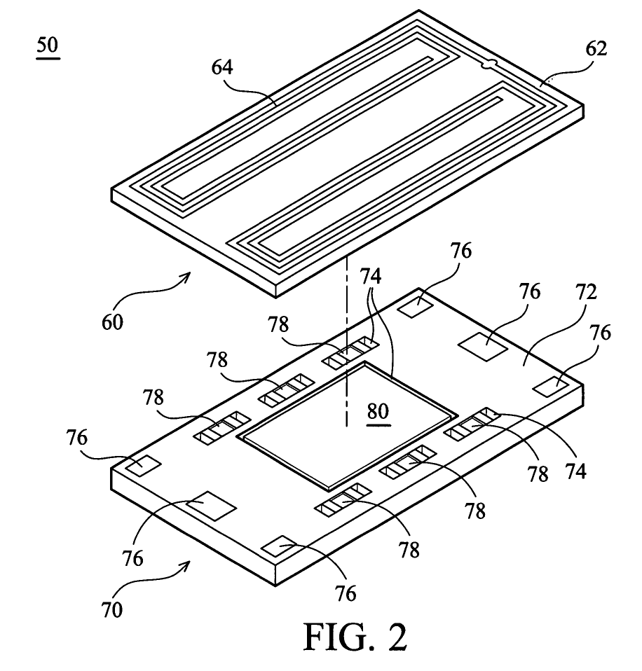

FIG. 2 is a structural diagram of an exemplary embodiment of a wireless communication module. The wireless communication module 50 comprises a signal processing module and a wireless transmitting module. The signal processing, module comprises a base 70 and electronic elements 78 and 80. Base 70 comprises a surface 72 and cavities formed on surface 72. The wireless transmitting module comprises a plate 60 and a wireless transmitting element, such as an antenna 64.

Base 70 comprises a multi-layer ceramic structure formed by a low temperature co-fire ceramic (LTCC) technology. The cavities 74 are formed on a side of surface 72. Since LTCC technology can not utilize a patterning method to dispose active and passive components on the MLC, electronic elements 78 and 80 are embedded in the cavities 74 using a surface mounting technology (SMT). The signal processing module is a bluetooth module. Electronic element 80 is a bluetooth chip. Electronic elements 78 are resistors with high resistance, or capacitors with high capacitance. In other words, the signal processing module comprises passive components (not shown), such as a filter, a balance-unbalance converter (Balun), an inductor, a capacitor, and a resistor. The passive components are formed in the MLC by a patterning method.

Plate 60 of the wireless transmitting module comprises a surface 62. Antenna 64 is formed on surface 62 by the patterning method. The material of plate 60 is a low permittivity material such as a glass fiber, an organic compound, or a polytetra-fluoroethylene (PTFE) Antenna 64 is formed by an ink printing method or an etching method. The material of the antenna 64 is a metal material Surface 72 is further disposed with connection pads 76, by for example, a surface mounting bonding pad or a die bond bonding pad to connect plate 60 and base 70, or the signal processing module and the wireless transmitting module for integrating the bluetooth module with the patterning antenna 64 exposed to outside the bluetooth module.

Since the wireless communication module of the present invention disposes the antenna in the outside of the bluetooth module formed by MLC, the volume of the wireless communication module can be reduced. Additionally, the antenna is disposed in the base such that the difficulty, manufacturing time, and cost of the wireless communication module are reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wireless communication module comprising:
a base comprising a first surface and at least one cavity formed on the first surface;
a first electronic element disposed within the cavity;
a plate comprising a second surface; and
a wireless transmitting element formed on a second surface in a patterning method and exposed to the outside of the wireless communication module, wherein the plate is coupled to the base.

2. The wireless communication module as claimed in claim 1, wherein the wireless communication module is a bluetooth module.

3. The wireless communication module as claimed in claim 1, wherein the first electronic element is disposed within the cavity using a surface mounting technology (SMT).

4. The wireless communication module as claimed in, claim 1, wherein the first electronic element comprises at least one active component and a plurality of passive components.

5. The wireless communication module as claimed in claim 4, wherein the active component is a bluetooth single-chip and the passive components comprise a resistor and a capacitor.

6. The wireless communication module as claimed in claim 1, wherein the base is a multi-layer ceramic structure formed by a low temperature co-fire ceramic (LTCC) technology.

7. The wireless communication module as claimed in claim 6, further comprising a second electronic element formed in the multi-layer ceramic structure by a patterning method.

8. The wireless communication module as claimed in claim 6, wherein the second electronic element comprises passive components selected from a group of a filter, a balance-unbalance converter, an inductor, a capacitor, or a resistor.

9. The wireless communication module as claimed in claim 1, further comprising a plurality of connection pads disposed on the first surface, wherein the plate is coupled to the base through the connection pads.

10. The wireless communication module as claimed in claim 9, wherein each of the connection pads is a surface mounting bonding pad or a die bond bonding pad.

11. The wireless communication module as claimed in claim 1, wherein the wireless transmitting element is an antenna.

12. The wireless communication module as claimed in claim 1, wherein the wireless transmitting element is formed by an ink printing method or an etching method.

13. The wireless communication module as claimed in claim 1, wherein the material of the wireless transmitting element is a metal material.

14. The wireless communication module as claimed in claim 1, wherein the plate is made of a material with a low permittivity selected from a group of a glass fiber, an organic compound, or a polytetra-fluoroethylene (PTFE).

15. A wireless communication module comprising:
a signal processing module; and
a wireless transmitting module comprising:
a plate; and
a wireless transmitting element formed on a surface of the plate by a patterning method;
wherein the signal processing module overlaps the wireless transmitting module such that the wireless transmitting element is exposed to the outside of the wireless communication module.

16. The wireless communication module as claimed in claim 15, wherein the signal processing module is a bluetooth module.

17. The wireless communication module as claimed in claim 15, wherein the signal processing module is a multi-layer ceramic structure,formed by a low temperature co-fire ceramic (LTCC) technology.

18. The wireless communication module as claimed in claim 17, wherein the signal processing module comprises:
a plurality of cavities; and
a plurality of first electronic elements respectively embedded in the cavities.

19. The wireless communication module as claimed in claim 18, wherein the first electronic elements comprise at least one active component and a plurality of passive components.

20. The wireless communication module as claimed in claim 17, wherein the signal processing module further comprises a plurality of second electronic elements formed in the multi-layer ceramic structure by the patterning method.

21. The wireless communication module as claimed in claim 20, wherein the second electronic elements are passive components selected form a group of a filter, a balance-unbalance converter, an inductor, a capacitor, or a resistor.

22. The wireless communication module as claimed in claim 15, wherein the signal processing module further comprises a plurality of connection pads coupled to the wireless transmitting module.

23. The wireless communication module as claimed in claim 22, wherein each of the connection pads is a surface mounting bonding pad or a die bond bonding pad.
